(19) United States
(12) Patent Application Publication
(10) Pub. No.: US 2014/0019517 A1
(43) Pub. Date: Jan. 16, 2014

(54) WEB-HOSTED SHIPPING SYSTEM AND METHOD OF USE THEREOF

(71) Applicant: Michael Steven Fawcett, Guilford, CT (US)

(72) Inventor: Michael Steven Fawcett, Guilford, CT (US)

(73) Assignee: Neopost Technologies, Bagneux (FR)

(21) Appl. No.: 13/549,860

(22) Filed: Jul. 16, 2012

(51) Int. Cl. G06F 15/16

(52) U.S. Cl. 709/203

(57) ABSTRACT

A web-hosted shipping system is disclosed. The web-hosted shipping system includes a local host that executes an operating system and is in signal communication with a remote server. A display device is in signal communication with the local host under control of the operating system. A processor executes a web browser and web service provider under control of the operating system. A scale, productive of a weight signal, is in signal communication with the local host via the operating system. The web browser displays a web page provided by the remote server upon the display device and the web service provider is accessible to a web service call of the web page. The web service provider is responsive to the web service call to receive the weight signal from the scale and to transfer the weight signal to the web page.

### BACKGROUND OF THE INVENTION

The present disclosure relates generally to internet data transfer, and particularly to cross-domain transfer of peripheral data.

Systems that allow a user to process parcels for delivery by a carrier are known as shipping systems; or, if the intent of the system is to allow the user to choose from among services of more than one carrier, the system may be known as a carrier management system. By whatever name, these systems (hereinafter referred to as “shipping systems”) are designed to prepare parcels in accordance with the regulations of the carrier that will be picking up the parcels for later delivery.

PC-based shipping systems allow a range of peripheral networking capabilities (both internet and intranet) and the ability to store records and address lists while accepting data downloaded in a variety of ways. Scales used with these types of systems are directed to recording weight under control of the shipping application. Rating and services functionality are also managed by the application, while the system shops for an appropriate rate from a database within a memory contained within the PC or from a rating table provided by a server. The ability of the PC-based system to provide a communications link to a network, while allowing integration with a client's information systems, is perhaps the greatest strength of these systems. Network links via the internet provide the system with an interface to a great number and variety of carrier web sites, increased functionality, and parcel tracking Additionally, data relevant to shipping history for a particular location, or historical manifest data can be downloaded or uploaded in a quick and efficient manner as necessary.

Parcel shipping, in general, has benefitted from efficiencies associated with PC-based systems. Labels can be printed at the desktop, weighing scales are interconnected to PCs for inputting weight to parcel shipping applications, and manifests for recording the details of parcel pickup and delivery are printed at the desktop as well. Peripherals such as scanners and other input devices can be added for increased data delivery. One piece of data that shipping applications rely on in determining the cost of a shipment is parcel weight. The weight parameter may be used by a variety of different carriers in determining a cost for shipping a parcel via a variety of services available from each of the carriers.

In a PC-based environment that is serving as a stand alone system, or that is part of a local area network (LAN), or even a wide area network (WAN), the weight of a parcel can be entered directly to a shipping application from the associated weighing scale. However, in an internet-based environment, also referred to as a web-hosted shipping system, security protocols present a number of challenges to the transfer of weight from a PC-connected scale to a remote web-server. Use of a web browser typically provides a protected environment in which there is no direct link between the web browser and a hardware device managed by an operating system of a PC on which the web browser is running The protected environment is defined in what is known as “the same origin policy”, which permits scripts running on pages originating from the same site to access each other's methods and properties without restriction, but prevents access to most networks and properties across pages on different sites. One approach to provide access between a remote web-server and locally-connected hardware is to create a web browser specific intermediary, known as a “plug-in”, such as Microsoft's Active X. However, to provide access between the web browser and hardware, this approach requires a different, web browser specific plug-in for each web browser that may be used, such as Microsoft Internet Explorer, Mozilla Firefox, Google Chrome, Safari, Netscape, etc. . . . ). This requirement may add significant complexity to the development of internet-based shipping systems. Accordingly, there is a need in the art for a cross-domain peripheral data transfer arrangement that overcomes these drawbacks.

### BRIEF DESCRIPTION OF THE INVENTION

An embodiment of the invention provides a web-hosted shipping system. The web-hosted shipping system includes a local host that executes an operating system and is in signal communication with a remote server. A display device is in signal communication with the local host under control of the operating system. A processor executes a web browser and web service provider each under control of the operating system. A scale, productive of a weight signal, is in signal communication with the local host via the operating system. The web browser displays a web page provided by the remote server upon the display device. The web service provider is accessible to a web service call of the web page and is responsive to the web service call to receive the weight signal from the scale and to transfer the weight signal to the web page.

A further embodiment of the invention provides a method of communicating in a web-hosted shipping system. The method includes executing an operating system by a processor within a local host that is in signal communication with a remote server. The processor further executes a web browser and web service provider under control of the operating system. The method includes displaying a web page provided by the remote server upon a display device of the local host. The method proceeds by requesting a weight signal from the web service provider via a web service call of the web page and obtaining from the web service provider, the requested weight signal from a scale in signal communication with the local host. The method concludes with transferring the obtained weight signal to the web page.

These and other advantages and features will be more readily understood from the following detailed description of preferred embodiments of the invention that is provided in connection with the accompanying drawings.

### BRIEF DESCRIPTION OF THE DRAWINGS

Referring to the exemplary drawings wherein like elements are numbered alike in the accompanying Figures:

FIG. 1 depicts a block schematic diagram of an exemplary computer in accordance with an embodiment of the invention;

FIG. 2 depicts a block schematic diagram of a network arrangement in accordance with an embodiment of the invention;

FIG. 3 depicts a block schematic diagram of an embodiment of a web-enabled peripheral system in accordance with an embodiment of the invention;

FIG. 4 depicts a flowchart of process steps for a method of communicating between a web server and peripheral device in accordance with an embodiment of the invention;

FIG. 5 depicts a flowchart of process steps for a method of communicating between a web server and scale of a web-hosted shipping system in accordance with an embodiment of the invention; and

FIG. 6 depicts data communication between a Web server 72, Browser, and Web service provider in accordance with an embodiment of the invention.

### DETAILED DESCRIPTION OF THE INVENTION

An embodiment of the invention provides an arrangement for passing data from a computer-connected peripheral directly to a remote web server through a web browser running on the computer without the need for a browser plug-in intermediary. Stated alternatively, an embodiment of the invention provides a browser agnostic arrangement to transfer data from a peripheral to a remote web server. An embodiment of the disclosed subject matter includes an approach that allows a web page of a remote web server access to a locally running program which offers up web-services. This provides a web browser with access to locally-connected hardware via a web service provider on a local port.

In an embodiment, web services pass data across web sites via specific formats, such as SOAP and REST, for example. One data format known as JSONP allows data to be accessed from a web server across domains by exploration of the <script> open policy exploit. As used herein, the term “JSONP” shall refer to a complement to the base JSON data format, which is a lightweight text-based open standard designed for human-readable data interchange. The JSON format is described in RFC 4627. JSON is often used for serializing and transmitting structured data over a network connection, such as between a server and web application and is derived from the JavaScript scripting language for representing simple data structures and associative arrays, called objects. Despite its relationship to JavaScript, it is language-independent, with parsers available for many languages. JSONP provides a method to request data from a server in a different domain, something prohibited by typical web browsers because of the same origin policy. In an embodiment, the JSONP cross-domain call technique is used with a locally running program offering JSONP web services, and allows the web page access to the local computer operating system.

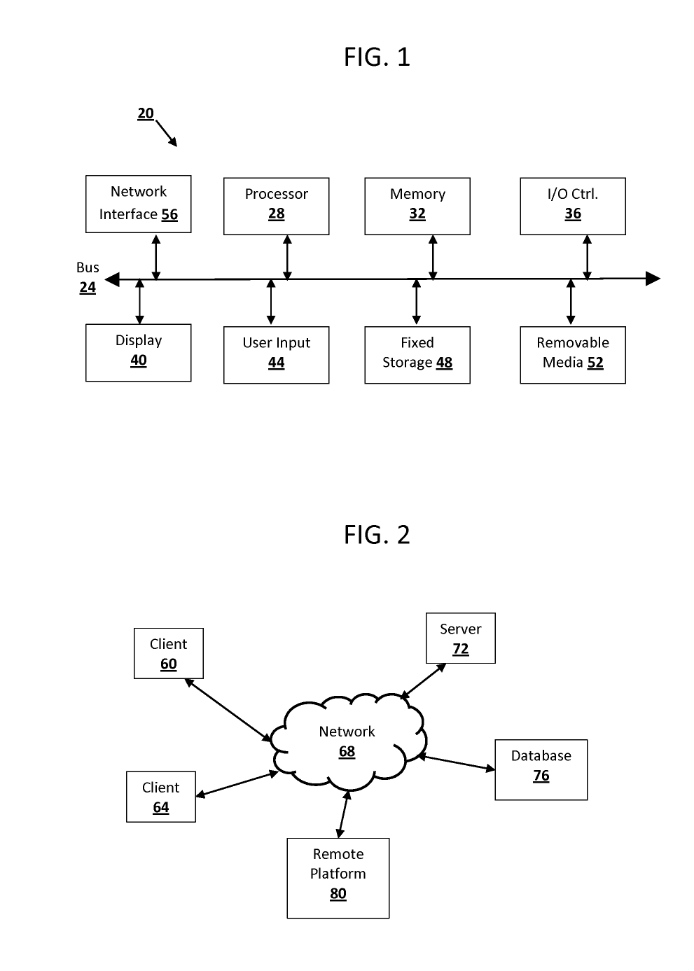

Embodiments of the disclosed subject matter may be implemented in and used with a variety of component and network architectures. FIG. 1 is an example computer 20 suitable for implementing embodiments of the disclosed subject matter. The computer 20 includes a bus 24 which interconnects major components of the computer 20, such as a central processor 28, a memory 32 (typically RAM, but which may also include ROM, flash RAM, or the like), an input/output controller 36, a user display 40, such as a display screen via a display adapter, a user input interface 44, which may include one or more controllers and associated user input devices such as a keyboard, mouse, and the like, and may be closely coupled to the I/O controller 36, fixed storage 48, such as a hard drive, flash storage, Fibre Channel network, SAN device, SCSI device, and the like, and a removable media component 25 operative to control and receive an optical disk, flash drive, and the like.

The bus 24 allows data communication between the central processor 28 and the memory 32, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 48), an optical drive, floppy disk, or other storage medium 52.

The fixed storage 48 may be integral with the computer 20 or may be separate and accessed through other interfaces. A network interface 56 may provide a direct connection to a remote server via a telephone link, to the Internet via an internet service provider (ISP), or a direct connection to a remote server via a direct network link to the Internet via a POP (point of presence) or other technique. The network interface 56 may provide such connection using wireless techniques, including digital cellular telephone connection, Cellular Digital Packet Data (CDPD) connection, digital satellite data connection or the like. For example, the network interface 56 may allow the computer 20 to communicate with other computers via one or more local, wide-area, or other networks, as shown in FIG. 2.

Many other devices or peripheral components (not shown) may be connected in a similar manner (e.g., scanners, scales, printers and so on). Conversely, all of the components shown in FIG. 1 need not be present to practice the present disclosure. The components can be interconnected in different ways from that shown. The operation of a computer 20 such as that shown in FIG. 1 is readily known in the art and is not discussed in detail in this application. Code to implement the present disclosure can be stored in computer-readable storage media such as one or more of the memory 32, fixed storage 48, removable media 52, or on a remote storage location.

FIG. 2 shows an example network arrangement according to an embodiment of the disclosed subject matter. One or more clients 60, 64 such as local computers, smart phones, tablet computing devices, and the like may connect to other devices via one or more networks 68. The network 68 may be a local network, wide-area network, the Internet, or any other suitable communication network or networks, and may be implemented on any suitable platform including wired and/or wireless networks. The clients 60, 64 may communicate with one or more servers 72 and/or databases 76. The devices may be directly accessible by the clients 60, 64, or one or more other devices may provide intermediary access such as where a server 72 provides access to resources stored in a database 76. The clients 60, 64 also may access remote platforms 80 or services provided by remote platforms 80 such as cloud computing arrangements and services. The remote platform 80 may include one or more servers 72 and/or databases 76.

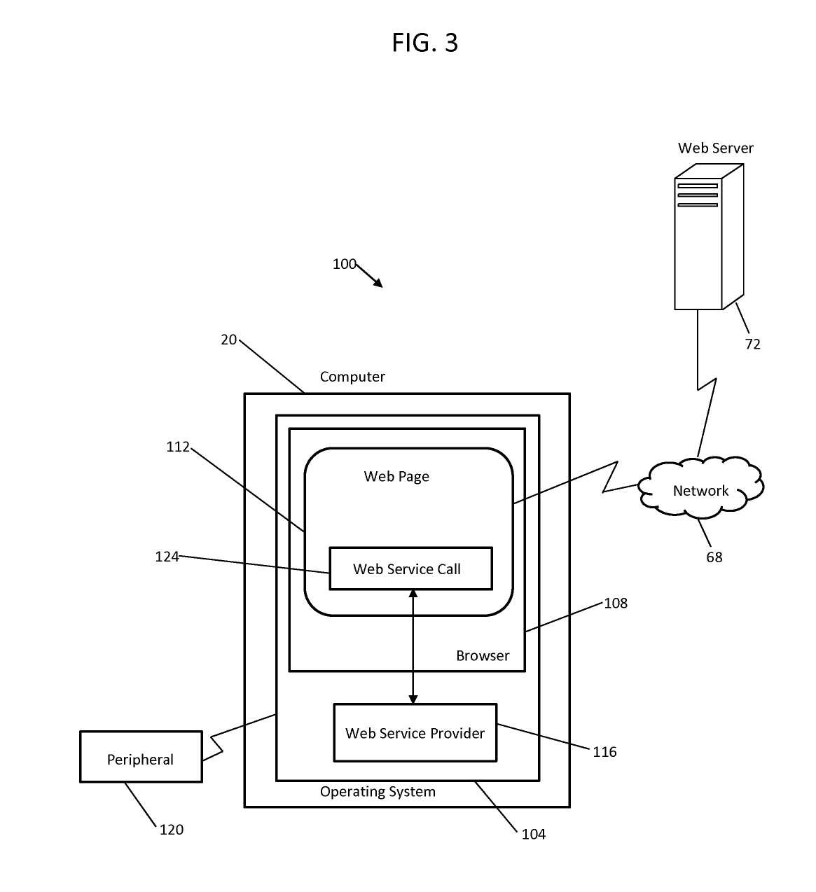

FIG. 3 depicts a schematic diagram of an embodiment of a web-enabled peripheral system 100. An operating system 104 executes on the processor 28 within the computer 20 of the system 100. As described above, the operating system 104 manages computer 20 hardware resources and provides common services for programs that are executed by the computer 20. Computer 20 represents a first domain, or local host, of the system 100.

A web browser 108 is a computer program executing on the processor 28, under control of the operating system 104. The web browser 108 retrieves, presents, and traverses information resources, or web pages 112, that are made available on the server 72, such as a web server 72, via the network 68. Web server 72 represents a second domain, or remote host, within the system 100. While an embodiment of the disclosed subject matter has been depicted having one web server 72, it will be appreciated that the scope of the invention is not so limited, and that the invention will also apply to web enabled peripheral systems 100 including more than one web server 72 as additional domains. Exemplary embodiments of the network 68 may also include the World Wide Web of the Internet, as well as web servers 72 that may be located within private networks, such as an Intranet via a Local Area Network connection, for example.

The web page 112 is an information resource that may be accessed through the web browser 108 for display upon the user display 40 of the computer 20. In an exemplary embodiment, the information is in HTML or XHTML format, and may provide navigation to other web pages via hypertext links. Web pages 112 may be retrieved from the local computer 20 or from the remote web server 72 via network 68. In some embodiments, the web page 112 may restrict access only to a private network, such as a corporate intranet, or it may publish pages on the World Wide Web. Web pages 112 may be requested and served from the web server 72 using Hypertext Transfer Protocol (HTTP).

Web pages 112 known as static web pages may include files of static text and other content stored within a file system of the web server 72 and provided to the web browser 108. Alternatively, web pages 112 known as dynamic web pages may be constructed by server-side software when they are requested. Client-side scripting, at the local host 20, can allow web pages 112 to be more responsive to user input to the browser 108.

A web service provider 116 is another computer program executing on the processor 28 under control of the operating system 104 of the computer 20. The web service provider 116 has access to any other devices or programs under the control of the operating system 104. The web service provider 116 represents a communications service that implements web-server functionality, but only to the extent necessary for one specific service stack. An example web service provider 116 may be constructed using a Windows Communication Foundation standard using standards and libraries that are written and used by the program, such as AJAX calls, for example.

In an embodiment, the web service provider 116 offers web services, such as JSONP web services, for example. In one embodiment, the web service provider 116 is a light-weight stand-alone program that is executed separately from the web browser 108 by the operating system 104 of the computer 20. The web service provider 116 may be may be a program that executes in the background, with no direct indication of it's execution. Alternatively, the web service provider 116 may indicate it's execution by presence of an icon within a system tray of the operating system 104 interface, for example. It will be appreciated by one of skill in the art that web service providers are typically part of remote web servers and are externally facing.

In an embodiment, the web service provider 116 is a JSONP service program that mimics the appearance and function of an external web server, such as the web server 72, but is executing on the operating system 104 within the same domain 20 as the web browser 108. The web service provider 116 executing on the local host 20 may be specialized to perform a specific function, and be reduced in application size and scope of functionality as compared to a web service provider that may be externally facing and executing upon a domain remote to the operating system 104, such as upon the web server 72. In an exemplary embodiment, the web service provider 116 may respond to service requests by listening, via the I/O controller 36, to a specific port of the computer 20, as will be described further below.

As described above with reference to FIGS. 1 and 3, the computer 20 includes the bus 24 to which various devices or peripherals 120 may be connected via the I/O controller 36 and managed by the operating system 104. In one embodiment, the system 100 is a shipping system with a shipping application provided by the web server 72 and the peripheral 120 is a scale 120. The shipping application is made available to a user via web pages 112 accessed by the browser 108 executing on the computer 20.

A web service call 124 is a scripted instruction of the web page 112 provided by the web server 72. In an embodiment, the web service call 124 is a JSONP service call 124 made directly to a JSONP service provider 116 executing under control of the operating system 104 within the local host 20. An example web service call 124 to the web service provider 116 may include a request for access to resources under control of the operating system 104 of the local host, or computer 20. An exemplary web service call 124 may include a JSONP service call 124 from the shipping application provided by the web server 72 for direct access to a specific device controller to which the scale 120 is associated, and may include a “get weight” function to poll the scale 120 for a weight of an object upon the scale 120.

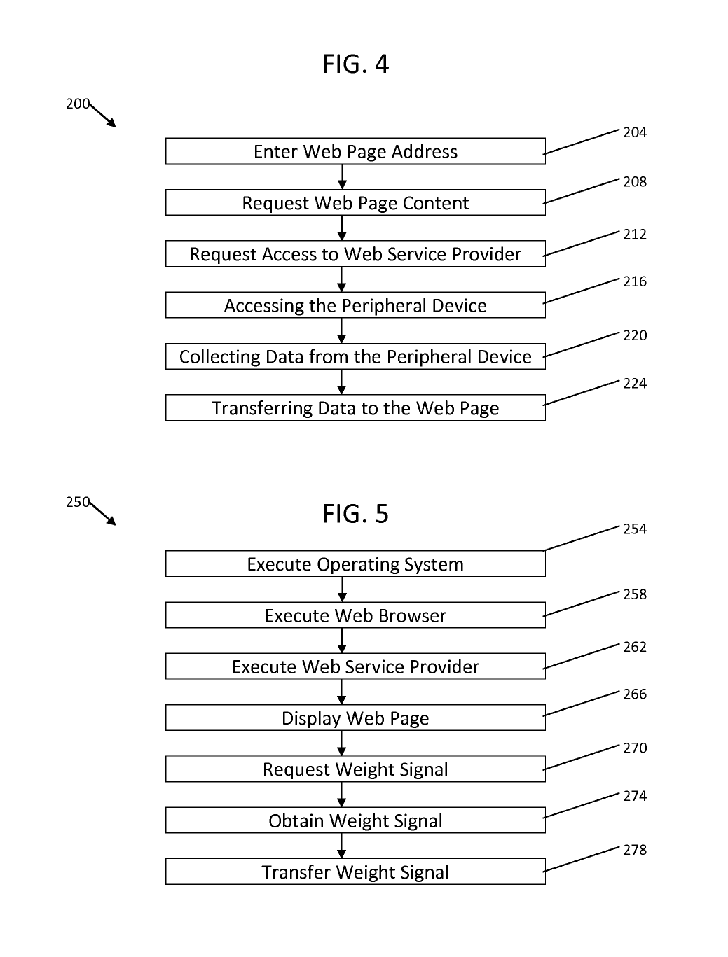

In view of the foregoing, the system 100 facilitates a method of communicating between a remote web server 72 and a peripheral device 120. FIG. 4 depicts a flowchart 200 of process steps for a method of communicating between the web server 72 and peripheral device 120.

The method begins at process step 204, with a user of the computer 20 entering, via the web browser 108, an address of a web page 112 associated with a remote domain, such as the remote web server 72. It will be appreciated that the user may enter the address of the web page 112 in a variety of manners, such as to directly provide a uniform resource indicator corresponding to the web page 112, selecting a hyperlink that links to the web page 112, or entering an IP address corresponding to the web page 112, for example. The method continues at process step 208, with the web browser 108 requesting, through the network interface 56 (under control of the operating system 104), for the web page 112 content to be delivered to the browser 108 via the network 68. At least some of the content of the web page 112 includes scripting for the web service call 124. In an exemplary embodiment, the web service call 124 is a JSONP cross-domain service call.

As used herein, the term “cross-domain service call” indicates a service call that is initiated by one domain for access to a service being hosted upon another domain. Such cross-domain service calls are typically directed from one remote host to another remote host. For example, a first remote web server 72 may make a cross-domain service call to a second remote web server (upon which a web service provider is running) For example, a shipping application may be running upon the first remote web server and may initiate the cross-domain service call to the second remote web server to obtain a rate to ship a particular parcel via a specific carrier. As another example, the second remote web server may include a web service provider having advertising content to be included upon the web page generated by the first remote web server. An embodiment of the disclosed subject matter includes the web service provider 116 executing upon the local host 20 under control of the operating system 104. Thus, instead of being directed to a second remote web server, the cross-domain service call made from the first remote web server 72 is directed to the local host 20.

The method continues at process step 212 with the web service call 124 requesting direct access to the web service provider 116, which is running under control of the same operating system 104 (within the local host 20) as the web browser 108. In an embodiment, the browser 108 allows a cross-domain call from the web page 112 provided by the remote web server 72 (as the remote domain) to the web-service provider 116, which is part of the local host domain 20.

At process step 216, the method continues with the web service provider 116 accessing the peripheral device via the corresponding hardware interface of the I/O control 36. In an exemplary embodiment, the web service provider 116 acts as a listener to a specific I/O controller 36 interface of the computer 20, such as a specific port of the controller 36 of the computer 20, for example.

At process step 220, the method continues with the web service provider 116 collecting data from the peripheral device 120 through the I/O control 36 hardware interface. Process step 224 includes transferring the data from the web service provider 116, through the web service call 124 to the web page 112.

With reference back to FIG. 3, a non-limiting specific example of a web-enabled peripheral system 100 includes a web-enabled shipping system 100. The web-enabled shipping system 100 includes a shipping server 72 upon which a shipping application executes. The shipping application is presented to a user of the computer 20 via the web browser 108 as described above. In an embodiment of the shipping system 100, the peripheral 120 is a scale, such as a USB scale 120 connected to the I/O controller 36 of the computer and thus in signal communication with the computer 20 via the operating system 104. The web service provider 116 is a JSONP service program that connects to the USB scale 120 to send and receive weight signal data from the scale 120 via the I/O controller 36 and functions as a small web service server that responds to service calls. For example, the web service call 124 may be a get weight call 124, in order for the shipping application to request a weight of an object upon the scale 120. An exemplary scale 120 may communicate with a device of the I/O controller 36, and the JSONP service program 116 may listen on port 50,000 and be responsive to the get weight call 124, to get any weight data being provided by the scale 120 and transfer such to the JSONP service call 124.

In an embodiment, an initiation process for the shipping system 100 may include provision of the web service provider 116 by the web server 72. That is, the computer 20 may download the web service provider 116 from the web server 72 as part of an initiation process before use of the shipping system 100. The web service provider 116 may include the necessary drivers to communicate with a specific set of web scales 120 for use with the shipping system 100. The initiation process may also include the JSONP service program 116 examining a USB device stack of the I/O controller 36 to determine if a scale 120 is attached to the computer 20. In an embodiment, the JSONP service program 116 will determine if the scale 120 is attached to the computer by examining the USB device stack to confirm presence (or absence) of a scale identifier associated with one of the specific set of web scales 120 for use with the shipping system 100.

In view of the foregoing, an exemplary embodiment of the system 100 facilitates a method of communicating in a web-hosted shipping system 100. FIG. 5 depicts a flowchart 250 of process steps for a method of communicating between web server 72 and scale 120 of the web-hosted shipping system 100.

The method begins at process step 254, with executing an operating system by the processor 28 within the local host computer 20, which is in signal communication with the remote server 72. The method continues at process steps 258 and 262 with executing, by the processor 28 the web browser 108 and web service provider 116 under control of the operating system 104.

At process step 266, the method continues by displaying, via web browser 108, the web page 112 (provided by the remote server 72) upon the display device 40 of the local host computer 20. At process step 270, the method continues by requesting, by the web service call 124 of the web page 112, a weight signal from the web service provider 116. In an embodiment, the request is initiated in response to the user selecting a query provided by the web page 112, such as a “GET WEIGHT” button for example.

At process step 274, the method includes obtaining the requested weight signal from the scale 120 in signal communication with the local host computer 20 by the web service provider 116 via the operating system 104. At process step 278, the method concludes with transferring the obtained weight signal to the web page 112, and thus, the remote server 72.

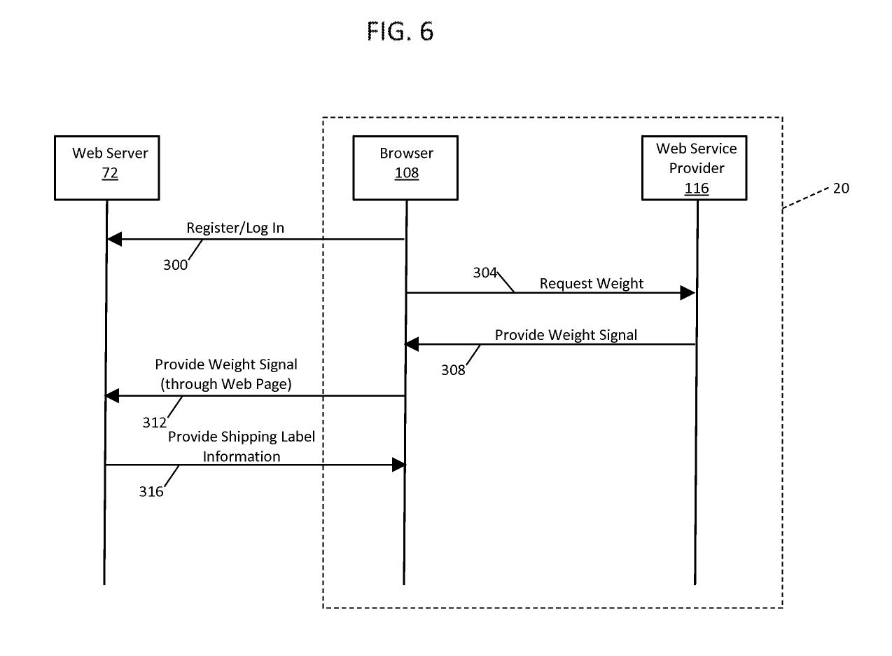

FIG. 6 is a schematic diagram depicting data communication between the web server 72, browser 108 and web service provider 116. Browser 108 and web service provider 116 are separate applications that each execute on the same local domain, or computer 20. The browser 108 communicates with the web service provider 116 and web server 72 in a similar manner, and acts as an intermediary between them. That is, although the browser 108 and web service provider 116 execute on the same domain, the browser 108 is responsive to the web service call 124 to communicate with the web service provider 116 in manner similar to the remote web server 72.

In an exemplary use of the shipping application, a user of the computer 20 may enter log-in information 300 which is provided to the server 72 via the browser 108. Once the user is authenticated, they may request a shipment by providing appropriate shipment information, such as delivery address and service, for example. One component of shipment information may include weight of a parcel upon a scale. In order to determine the weight, the user may select a button such as “GET WEIGHT” displayed upon the web page 112 by the browser 108. In response to the user's selection of the “GET WEIGHT” button, the browser 108 may initiate a java script to perform the web service call 124, in a manner similar to a call to a remote web server, to request weight data 304 from the web service provider 116. As described above, the web service provider 116 may obtain weight data from the scale 120 attached to the computer 20 via the I/O controller 36 under control of the operating system 104. The web service provider 116 then returns the weight data 308 to the browser 108. The browser 108 is responsive to receipt of the weight data 308 to forward the full shipment information (including weight data) 312 to the server 72 through the web page 112. With the weight data and other shipment information, the server 72 has sufficient information to generate a shipping label, and forwards the shipping label information 316 (such as a printable pdf file, for example) to the browser 108. In some embodiments, in order to generate the shipping label, the server 72 may communicate with further remote servers, such as to determine a carrier-specific shipping rate for example.

A result of using the disclosed web service provider 116, executing on the local host 20, is that access to peripherals executing on the local host 20 may be accessed by the remote web server 72 via a cross-domain service call by the browser 108 without any browser-specific plug-ins. It will be appreciated by one of skill in the art that incorporation of a standard web service provider upon the local host 20 would not ordinarily be contemplated because of the size, resource consumption, and administrative burden typically associated with web service providers. Typical users of web-enabled programs are not interested (and commonly not capable) to administer a web service provider as part of their use of a web-enabled program. Only through the reduction in size and transformation to a single purpose application has the potential to locate the web service provider 116 upon the local host 20 been realized.

While an embodiment of the invention has been described with the web service provider 116 interfaced to the peripheral 120, it will be appreciated that the scope of the invention is not so limited, and that the invention also applies to arrangements in which the web service provider 116 may interface directly with the operating system 104 within which the web service provider 116 is executing, such as to change a setting of the operating system 104. An example change may be to allow the remote web server 72 to change a display 40 resolution setting via the operating system 104. Further, while embodiments of the invention have been described with the web service provider 116 executing within the operating system 104, it will be appreciated that the scope of the invention is not so limited, and that the disclosed subject matter may also apply to arrangements in which the web service provider may be executed within the peripheral 120 itself, allowing the peripheral 120 to be directly accessed by the remote server 72. That is, the communications mechanism between the browser 108 (and therefore the shipping application executing upon the remote server 72) and the web service provider 116 is a standard web services communication, which means that the web-service provider 116 can be running anywhere.

More generally, various embodiments may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing embodiments of the invention. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing embodiments of the invention. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to various embodiments in hardware and/or firmware. The processor may be coupled to memory, such as RAM, ROM, flash memory, a hard disk or any other device capable of storing electronic information. The memory may store instructions adapted to be executed by the processor to perform the techniques disclosed herein.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A web-hosted shipping system comprising:
a local host in signal communication with a remote server, the local host comprising:
a display device in signal communication with the local host;
a processor executing an operating system, a web browser, and a web service provider, the web browser and web service provider under control of the operating system, the web browser displaying a web page provided by the remote server upon the display device, the web service provider accessible to a web service call of the web page; and
a scale in signal communication with the local host via the operating system and productive of a weight signal;
wherein the web service provider is responsive to the web service call to receive the weight signal from the scale and to transfer the weight signal to the web page.

2. The web-hosted shipping system of claim 1, wherein the processor separately executes the web browser and the web service provider under control of the operating system.

3. The web-hosted shipping system of claim 1, wherein the web service provider is a JSONP web service provider.

4. The web-hosted shipping system of claim 3, wherein the JSONP web service provider is responsive to the web service call to listen on a communication port of the local host to obtain the weight signal produced by the scale.

5. The web-hosted shipping system of claim 1, wherein the web service call is a JSONP web service call.

6. The web-hosted shipping system of claim 4, wherein the web service call is a JSONP cross-domain web service call.

7. The web-hosted shipping system of claim 6, wherein the web service provider is a JSONP web service provider and the web service call is a direct web service call to the JSONP web service provider.

8. The web-hosted shipping system of claim 1, wherein:
the remote server is responsive to receipt of the weight signal by the web page to:
produce a shipping label; and
provide the shipping label to the web page.

9. The web-hosted shipping system of claim 1, wherein:
following transfer of the weight signal to the web page from the web service provider, the local host is receptive of a shipping label provided by the remote server

10. A method of communicating in a web-hosted shipping system, the method comprising:
executing an operating system by a processor within a local host in signal communication with a remote server;
executing, by the processor, a web browser under control of the operating system;
executing, by the processor, a web service provider under control of the operating system;
displaying, by the web browser, upon a display device of the local host, a web page provided by the remote server;
requesting, by a web service call of the web page, a weight signal from the web service provider;
obtaining by the web service provider, via the operating system, the requested weight signal from a scale in signal communication with the local host; and
transferring the obtained weight signal to the web page.

11. The method of claim 10, wherein the web service provider is a JSONP web service provider.

12. The method of claim 10, wherein the web service call is a JSONP web service call.

13. The method of claim 12, wherein the web service call is a JSONP cross-domain web service call.

14. The method of claim 13, wherein the web service call is a direct web service call to a JSONP web service provider.

15. The method of claim 10, further comprising:
receiving shipping information comprising the transferred weight signal;
producing a shipping label based upon the received shipping information; and
providing the shipping label to the web page.
